(19) United States
(12) Patent Application Publication
(10) Pub. No.: US 2007/0089620 A1
(43) Pub. Date: Apr. 26, 2007

(54) Printing apparatus, control method thereof and manufacturing method of flat panel display using the same

(76) Inventors: Hoon Kim, Gyeonggi-do (KR); Jung-mi Choi, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/580,552

(22) Filed: Oct. 12, 2006

(30) Foreign Application Priority Data
Oct. 14, 2005 (KR) 2005-0097213

(51) Int. Cl. B05C 17/04

(52) U.S. Cl. 101/123

(57) ABSTRACT

A printing apparatus that can form an even thin film on a substrate, a method of controlling the printing apparatus, and a method of manufacturing a flat panel display are presented. The printing apparatus includes a table on which a substrate is mounted, a mask located on the table and having a mesh part framed by a supporter, a squeegee capable of moving across the mask to form a thin film on the substrate, a squeegee driver for driving the squeegee, and a controller for controlling the squeegee driver to stop the squeegee at a boundary area between the mesh part and the supporter for a predetermined time period.

### CROSS-REFERENCE TO RELATED APPLICATIONS

This application claims priority from Korean Patent Application No. 2005-0097213 filed on Oct. 14, 2005 in the Korean Intellectual Property Office, the disclosure of which is incorporated herein by reference.

### BACKGROUND OF THE INVENTION

1. Field of Invention

The present invention relates generally to a printing apparatus and particularly to a printing apparatus that is capable of forming a uniformly thin film on a substrate.

2. Description of the Related Art

Today, the role of OLED (Organic Light Emitting Diode) in the field of a flat panel display industry is becoming increasingly important. This increasing importance of OLED is at least partly due to its advantageous characteristics such as low driving voltage requirement, light weight, thinness, wide viewing angle, and quick response time.

An OLED includes a first substrate provided with organic layers such as an organic light-emitting layer, a hole-injecting layer, a hole-transporting layer and the like deposited on the substrate, and a second substrate coupled to the first substrate. The first and second substrates are positioned in substantially parallel planes. A thin film is interposed between the first substrate and the second substrate for assembling the two substrates and preventing the inflow of moisture or oxygen into the OLED, and such a thin film is formed over the whole surface of the substrate.

Here, the thin film may be an organic film that can be formed on the substrate by the printing method.

The printing method entails forming a thin film uniformly on the substrate by using a mask. The mask has a mesh part and a supporter surrounding the mesh part. The mask is positioned over the substrate and a squeegee that is wet with a film material is passed over the mask while being pressed toward the substrate. This way, the film material fills the mesh part.

During the printing process, the mesh part that is pushed down by the squeegee changes its shape (e.g., stretches) to contact the thin film, and reverts back to a neutral position after the squeegee passes over it, allowing it to separate from the thin-film. Due to the viscosity of the thin film, the mesh part separates from the thin film more slowly than the moving speed of the squeegee. The supporter portion of the mask, which separates from the thin film faster than the mesh portion (because viscous thin film is not formed in the lower portion of the supporter), pulls on the mesh so that there is high tension level in the mesh. Due to this high tension level, when the mesh part finally separates from the thin film, the release from the thin film is sudden and fast, releasing the built-up tension.

A problem with this sudden release of the mesh is that it disturbs the uniformity of the thin film by causing a formation of a raised or deformed portion.

### SUMMARY OF THE INVENTION

Accordingly, it is an object of the present invention to provide to a printing apparatus that can form an even and uniform thin film on the substrate, a method of controlling the printing apparatus, and a method of manufacturing a flat panel display using the printing apparatus.

In one aspect, the invention is a printing apparatus that includes a table on which a substrate is mounted, a mask located on the table and comprising a mesh part framed by a supporter, a squeegee capable of moving across the supporter to form a thin film on the substrate, a squeegee driver for driving the squeegee, and a controller for controlling the squeegee driver to stop the squeegee at a boundary area between the mesh part and the supporter for predetermined time.

In another aspect, the present invention is a method for controlling a printing apparatus including arranging a mask on a substrate, wherein the mask has a mesh part framed by a supporter, placing a film material on one side of the supporter, placing a squeegee on the supporter, moving the squeegee across the mask while being pressed against the mesh part toward the substrate, stopping the squeegee in a boundary area between the supporter and the mesh part for a predetermined time period, and moving the squeegee toward the supporter after the predetermined time period.

In yet another aspect, the invention is a method of manufacturing a flat panel display that entails providing a substrate, arranging a mask on a substrate, wherein the mask includes a mesh part framed by a supporter, forming a thin film on the substrate by moving a squeegee across the mask, stopping the squeegee for a predetermined time in a boundary area between the mesh part and the supporter, moving the squeegee after the predetermined time and stopping the squeegee at the supporter.

### BRIEF DESCRIPTION OF THE DRAWINGS

The above and/or other aspects and advantages of the prevent invention will become apparent and more readily appreciated from the following description of the exemplary embodiments, taken in conjunction with the accompanying drawings, in which:

FIG. 1 is a plane view of a screen printing apparatus according to an embodiment of the present invention;

FIG. 2 is a sectional view of the screen printing apparatus taken along the line II-II of FIG. 1;

FIG. 3 is a sectional view of the screen printing apparatus taken along the line III-III of FIG. 1;

FIG. 4 is a sectional view of a squeegee that is stopped on one side of a supporter for a predetermined time;

FIG. 5 is a control block diagram of the screen printing apparatus according to an embodiment of the present invention;

FIG. 6 is a flow chart illustrating a control method of the screen printing apparatus according to an embodiment of the present invention; and

FIG. 7 is a sectional view of an OLED manufactured by the screen printing apparatus according to an embodiment of the present invention.

### DETAILED DESCRIPTION OF EMBODIMENTS

Reference will now be made to the embodiments of the present invention, examples of which are illustrated in the accompanying drawings wherein like reference numerals refer to like elements throughout. The embodiments are described below so as to explain the present invention by referring to the figures.

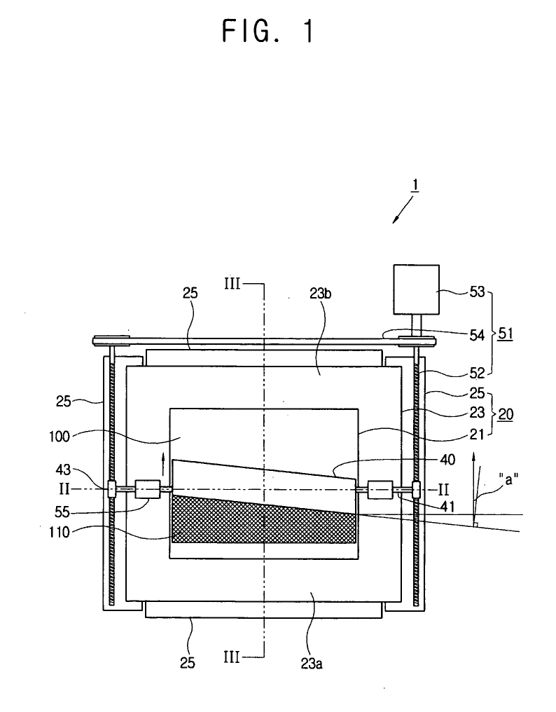

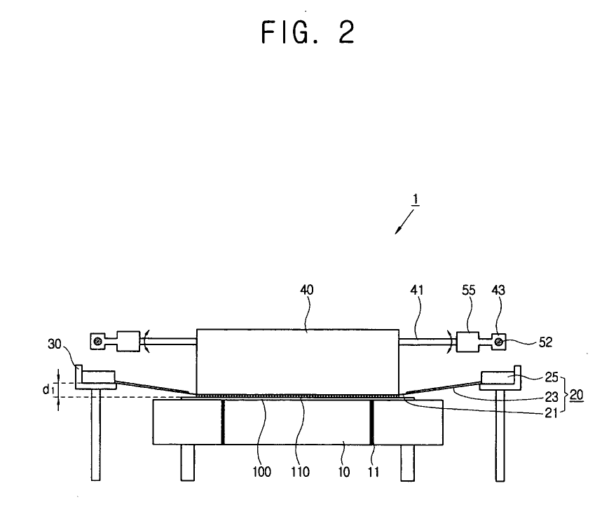

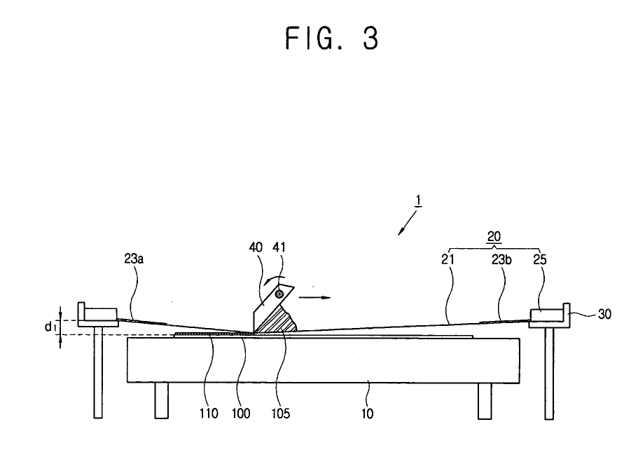

FIG. 1 is a plane view of a screen printing apparatus according to an embodiment of the present invention, FIG. 2 is a sectional view of the screen printing apparatus taken along the line II-II of FIG. 1, and FIG. 3 is a sectional view of the screen printing apparatus taken along the line III-III of FIG. 1.

A screen printing apparatus 1 according to an embodiment of the present invention comprises a table 10 on which a substrate 100 is mounted stably; a mask 20 placed on the table 10; a mask supporting part 30 that supports at least one side of the mask 20 and spaces the mask 20 apart from the table 10; a squeegee scanning over the mask 20; a squeegee driver 51, 55 including a first driving motor 51 enabling rectilinear movement of the squeegee 40 from one side of the mask to the other side of the mask and a second driving motor 55 enabling squeegee 40 to lift up and down; and a controller 60 for controlling the squeegee driver 51, 55.

The substrate 100 that is an object to be processed is mounted stably on the table 10 that is furnished with at least one mounting pin 11. As the substrate 100 is transported on the table 10 by a transporting apparatus like a robot, the mounting pin 11 in the table 10 is raised for supporting the substrate 100 stably. The substrate 100 is stably positioned on the table 10 by descending as the mounting pin 11 moves downward, receding back into the table 10.

The mask 20 is placed on the table 10. The mask 20 includes a mesh part 21 corresponding to the substrate 100, a supporter 23 surrounding the mesh part 21, and a mask frame 25 that is provided at least on an edge of the supporter 23 for preventing the mask 20 from moving. The mesh part 21 may have a quadrangular shape and openings that are typically of a square or a diamond shape. The size of the mesh part 21 is the same as or smaller than the size of the substrate 100. The supporter 23 is made of a flexible material including plastic, and fastens to the edge of the mesh part 21 to pull the mesh part 21 and prevent it from sagging or hanging down. The supporter 23 moves up and down with the mesh part 21 by pressurization of the squeegee. Being stably mounted on the mask supporting part 30 described below, the mask frame 25 supports the mask 20 and prevents it from moving or sliding during the operation with the squeegee 40.

The mask supporting part 30 is provided on opposite sides of the table 10. The mask supporting part 30 prevents the mask 20 from moving during the operation of the squeegee 40, and supports the mask 20 by spacing from the substrate in a predetermined gap. A gap d1 between the mask 20 and the substrate 100 can be changed according to the size of the substrate 100, and is typically in the range of about 5 cm to 30 cm. If the substrate size is about 730*920 mm, the gap d1 is about 10 cm.

The squeegee 40 forms a thin-film 110 on the substrate 100 by placing the film material 105 on the mesh part 21 during scan operation in the mask 20, as shown in FIG. 3. In more detail, the squeegee 40 executes rectilinear motion from one side of the supporter 23a toward the other supporter 23b facing the one side supporter 23a in the mask 20, and pushes the film material 105 accumulated at one side of the supporter 23a through the mesh part 21. At the same time, the squeegee 40 presses the mesh part 21 toward the substrate 100, forming the thin-film 110 having a predetermined thickness on the substrate 100. The mesh part 21 pressed by the squeegee 40 is stretched to contact the thin film 110, and separated from the thin-film 110 after the squeegee 40 moves on.

Due to the viscosity of the thin film 110, the mesh part 21 is separated from the thin film 110 more slowly than the moving speed of the squeegee 40. Accordingly, when the mesh part 21 finally separates from the thin film 110, the separation is rapid. The rapid speed of this separation is caused at least in part by the supporter 23 pulling on the mesh part 21. Also, the speed at which the supporter 23 separates from the substrate 100 is higher than the speed at which the mesh part 21 separates from the thin film 110 on the substrate 100. This is because the viscous thin film 110 is not formed in the lower portion of the supporter 23. Due to the rapid separation of the mesh part 21 from the thin film 110 and the supporter 23 separating from the substrate 100 at a different speed than the mesh part 21 separating from the thin film 110, the thin film 110 is not formed uniformly. More specifically, the portion of the thin film 110 that separated rapidly from the mesh part 21 is raised or deformed. This nonuniformity causes a defect in the formation of other elements on the thin film 110 (like cathode), ultimately degrading the image quality by allowing oxygen or water to reach the elements.

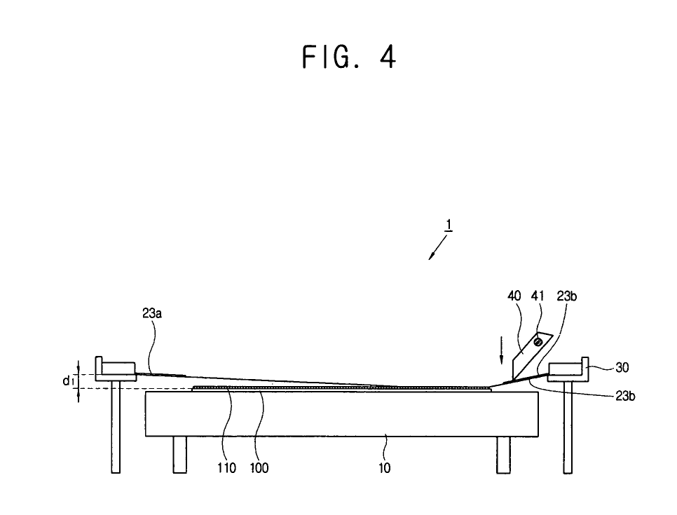

The invention is based on the discovery that this problem can be alleviated by matching the speed at which the supporter 23 is separated from the substrate 100 and the speed at which the mesh part 21 is separated from the thin film 110. As shown in FIG. 4, the squeegee 40 is stopped for a short time at the boundary between the mesh part 21 and the supporter 23b.

For reducing the speed at which the mesh part 21 is separated from the thin film 110 on the substrate 100, the part of the mesh part 21 near the supporter 23b may be pressed by the squeegee 40. By doing this, the upward force on the part of the mesh part 21 that is in contact with the thin film 110 is reduced, and the speed at which the mesh part 21 separates from the thin film 110 is made to substantially match the speed at which the supporter 23 separates from the substrate 100. Thus, film uniformity is improved by minimizing the rise of the thin film 110 caused by a sudden release from the mesh portion 21.

The squeegee 40 contacting the mesh part 21 scans over the mask 20 and proceeds in a direction that makes a predetermined angle with respect to a side of the squeegee 40. This is for forming an even film by placing the film material 105 on the mesh part 21, and the angle “a” (shown in FIG. 1) may be varied according to the design pattern of the mesh part 21. The angle “a” may be approximately 5 to 50 degrees in some embodiments. The squeegee 40 may be a long stick having a portion that is covered with soft material like rubber for contacting with the mesh part. The length of the squeegee 40 is the same as or smaller than the width of the mesh part 21. An operating shaft 41 pierces the squeegee 40, and the bearing 43 is provided on opposite ends of the operating shaft 41.

The squeegee driver 51, 55 includes the first driving motor 51 enabling rectilinear movement of the squeegee 40 from one side of the mask 20 to the other side of the mask 20 and the second driving motor 55 enabling the squeegee 40 to lift up and down.

As seen in FIG. 1, in the first driving motor 51, rotating shafts 52 that are formed like long screws are placed along two parallel sides of the mask 20 separated by a predetermined gap, and the motor 53 is connected to one of the rotating shafts 52 to rotate the rotating shaft 52. The other one of the rotating shafts 52 is connected to the motor 53 through a belt 54, so that both rotating shafts 52 concurrently rotate at the same speed. The rotating shaft 52 is inserted in the bearing 43, and the squeegee 40 executes rectilinear movement as the screw portion of the rotating shaft 52 engages the pattern formed with the bearing 43. In other embodiments, separate motors may be employed for the two rotating shafts individually. Alternatively, the rotating shaft 52 may be provided with a rack gear formed on the ends of the operating shaft 41, enabling rectilinear movement of the squeegee 40 as the rack gear engages with a pinion gear.

Referring to FIG. 2, the second driving motor 55 is placed on the driving shaft 41 piercing the squeegee 40 and controls the up/down motion of the squeegee 40. By rotating the driving shaft 41 by a predetermined angle, the second driving motor 55 controls the distance between the squeegee 40 and the substrate 100. Namely, after enabling the bottom of the squeegee 40 to contact the mesh part 21 by rotating the squeegee 40 by the predetermined angle, the squeegee 40 performs rectilinear movement by operation of the first driving motor 51. In another embodiment, the squeegee 40 may be structured to perform the up/down rectilinear movement using a motor, a gear, and a bearing, etc. without using a rotating part. The second driving motor 55, as seen in the figure, may be provided on both sides or on one side of the driving shaft 41. The second driving motor 55 causes the film material 105 of the mesh part 21 to be pressed toward the substrate 100, thereby forming the thin film 110 on the substrate 100.

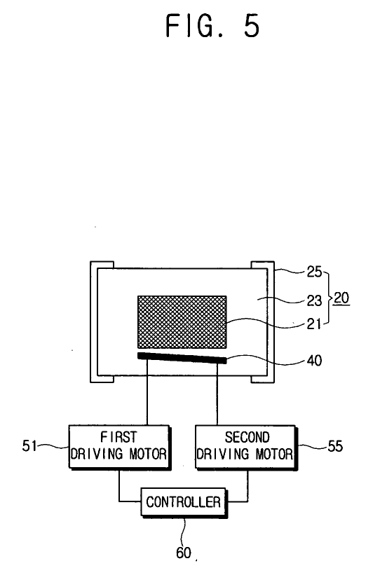

As shown in FIG. 5, the controller 60 for controlling the squeegee driver 51, 55 may be provided on one side of the screen printing apparatus 1. The controller 60 controls the first driving motor 51 to stop the squeegee 40 at the boundary between the supporter 23b and the mesh part 21 for a predetermined time period. Once the squeegee starts to operate, the controller 60 can determine the current position of the squeegee 40 by counting the number of rotations executed by the motor 53 in the first driving motor 51. Through such determination, once the squeegee 40 is placed on the side of the supporter 23b adjacent to the mesh part 21, the controller 60 controls the first driving motor 51 to stop the squeegee 40. The controller 60 can stop the squeegee 40 when the mesh part 21 near the supporter 23b is separated from the thin film 110 formed on the substrate 100. Also, by determining the viscosity of the thin film 110 and the tension that the mesh part 21 receives, the separating speed of the mesh part 21 from the thin film 110 can be maintained relatively constant during the separation. The controller 60 determines and counts the factors (e.g., time) that are used in maintaining constant separation speed. In some embodiments, the controller 60 can control the first driving motor 51 to stop the squeegee 40 for a time period between 1 second and 5 minutes. If the stop time of the squeegee 40 is too short, the raised portion or other forms of unevenness in the thin film 110 can be generated since the supporter 23 separates from the substrate 100 faster than the mesh part 21 from the thin film 110. On the contrary, if the stop time of the squeegee 40 is too long, time is spent inefficiently and productivity becomes low.

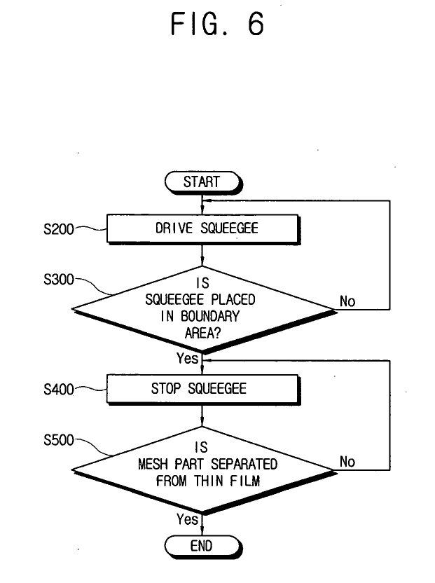

Now, the principle and process for forming the thin film by using the screen printing apparatus 1 having having the above structure will be explained. FIG. 6 is a flow chart explaining a control method of the screen printing apparatus 1 according to an embodiment of the present invention.

Once the substrate 100 is stably mounted on the table 10, the mask 20 including the mesh part 21 and the supporter 23 surrounding the mesh part 21 is arranged on the substrate 100. The film material 105 is contained at one side of the supporter 23a.

The film material may be a radical type bonding agent or a cation-type bonding agent using a resin. For the radical type bonding agent, the resin may be a thermo setting resin like a urea resin, melamine resin, phenol resin, resorcinol resin, epoxy resin, unsaturated polyester resin, polyurethane resin or acrylic resin, a thermoplastic resin like a vinyl acetate resin, vinyl ethylene-acetate copolymer resin, acryl-resin, cyanoacrylate resin, poly vinyl alcohol resin, polyamide resin, polyolefin resin, thermoplastic polyurethane resin, saturated-polyester resin, cellulose, or the like, an acetate of every kind containing an ester-acrylate, urethane-acrylate, epoxy-acrylate, melanin acrylate, or acryl-resin-acrylate, and an urethane-polyester. For the cation-type bonding agent, the resin may be an epoxy, vinyl ether, or the like, a thiol/N-additive resin bonding agent, or a complex polymer bonding agent using composition including rubber like, chloroprene-rubber, nitril-rubber, stylene-butadiene rubber, natural rubber, butyl rubber, or silicon, or phenolic composition containing vinyl-phenol, chloroprene-phenol, nitril-phenol, nylon-phenol, epoxy-phenol, or the like. The materials listed herein are illustrative and not limiting of the invention. Also, a filler may be inserted in the film material 105. For example, inorganic material like SiOx, SiON, SiN, etc., or a metal like Ag, Ni, Al, etc. may be used as a filler but other materials not specifically mentioned herein may also be used. The film material 105 may be cured using UV ray, visible light, combination of UV ray and heat, heat, or post-curing, among others.

With the film material 105 contained at one side of the mesh portion 21, the controller 60 operates the squeegee driver 51, 55 to place the squeegee 40 on one side of the supporter 23a. Subsequently, as seen in FIG. 6, the controller 60 activates the scan-operation of the squeegee 40 on the substrate 100 from the supporter 23a to the supporter 23b (S200). At this time, by pressing the mesh part 21 toward the substrate 100, the squeegee 40 allows the thin film 110 to form on the substrate 100.

During the operation of the squeegee 40, the controller 60 determines the current position of the squeegee 40 by counting the number of rotations of the motor 53 that enables the rectilinear movement of the squeegee 40. Alternatively, a sensor may be used to determine the current position of the squeegee 40. The controller 60 determines whether the squeegee 40 is placed at the boundary between the mesh part 21 and the supporter 23b (S300), so that the squeegee 40 is continuously operated by the controller 60 when the squeegee 40 is placed in the area before the boundary, and the squeegee 40 is stopped for a predetermined time by the controller once the squeegee 40 reaches the boundary area (S400). Then, the controller 60 calculates the stop time of the squeegee 40 (S500). Namely, the controller 60 determines the amount of time where the portion of the mesh part 21 that is adjacent to the supporter 23b is separated from the thin film 110, and stops the squeegee for that time period. To determine the stop time, the controller 60 may collect in advance data about the viscosity of the thin film 110 and the tension between the mesh part 21 and the supporter 23. In other embodiments, the squeegee 40 can be controlled to stop for previously setup time. The set up time can be inputted differently according to the size and viscosity of the thin film 110 on the substrate 100. In some embodiments, the controller 60 can control the first driving motor 51 to stop the squeegee 40 for any duration between 1 second to 5 minutes. In selecting the exact duration, the stop time of the squeegee 40 should not be too short because then the object of the invention can not be achieved, as explained above. On the other hand, when the stop time is too long, the productivity becomes low due to an increase in processing time.

By controlling the screen printing apparatus in the manner described above, the separating speed of the mesh part 21 from the thin film 110 is constantly controlled from the beginning to the end so that the thin film 110 that is formed on the substrate 100 is even and uniform.

Then, when the entire mesh part 21 is separated from the thin film 110, the controller 60 allows the squeegee 40 to further move and stop it.

Now, a manufacturing method of flat panel display using the screen printing apparatus described above will be explained in detail. Though the above embodiments are described in the context of OLED of various flat panel displays, it is to be understood that the invention as claimed is applicable to the other flat panel display like an LCD, or a PDP, etc. As used herein, any film (layer) being formed (positioned) “on” the other film (layer) includes both the situation where the two films are in direct contact and the situation where intervening film (layer) exists between the two films (layers).

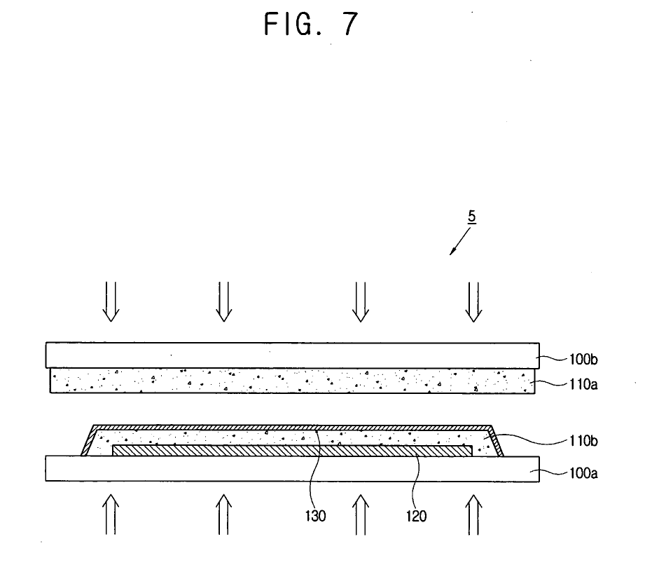

FIG. 7 is a sectional view of an OLED manufactured by the screen printing apparatus according to the present invention. An OLED 5 is a self-light emitting type element using organic matter that emits light in response to electrical signals. the life span and efficiency of the organic matter in the OLED is reduced by exposure to oxygen and moisture (water). So, it is important to employ a sealing method for effectively preventing oxygen and moisture from passing into the organic matter (organic light emitting layer).

According to the present invention, as seen in FIG. 7, the OLED 5 includes a first substrate 100a including organic elements 120 to display images, a second substrate 100b positioned in a plane parallel to the first substrate 100a for preventing oxygen and water from reaching the organic element 120, and thin films 110a, 110b positioned between the first substrate 100a and the second substrate 100b.

The first substrate 100a is a transparent substrate, and may be a plastic substrate or an organic substrate. Further, although not shown, an isolating layer may be formed between the organic element 120 and the first substrate 100a, namely on the upper surface of the first substrate 100a. The isolating layer including SiON, SiO₂, SiNx, and Al₂O₃, etc. isolates oxygen or water so that it does not pass into the organic element 120 by diffusing through the first substrate 100a, and can be formed by sputtering.

The organic element 120 incorporated by a known method includes an organic light-emitting layer, a hole injecting layer, and a hole transporting layer. The organic element 120 displays images in response to the image signals outputted from the information processing unit.

The second substrate 100b can be made with the same material as the first substrate 100b. In addition, soda-lime glass substrate, boro-silicate glass substrate, silicate glass substrate, and lead glass substrate, etc. can be used for the second substrate 100b. The thickness of the second substrate 100b may range between about 0.1 mm and about 10 mm, and preferably between about 1 mm and about 10 mm, for preventing water or oxygen from diffusing into the organic element 120 through the second substrate 100b.

The thin films 110a, 110b are positioned between the first and second substrates 100a, 100b. The thin films 110a, 110b contain a sealing material that prevents oxygen or water from diffusing through the space between the first substrate 100a and the second substrate 100b. At the same time, the thin films 110a, 110b couple the two substrates 100a, 100b to each other. The thin films 110a, 110b may contain an organic film, an inorganic film, or a complex film consisting of organic material and inorganic material. The organic film may be poly-acetylene, polyimide, and epoxy resin, etc., while the inorganic film may be silicon oxide, silicon nitride, magnesium oxide, aluminum oxide, aluminum nitride, and titanium oxide.

In FIG. 7 showing the foregoing embodiment, the thin films 110a, 110b containing an organic material are provided on both substrates 100a, 100b, and a protective layer 130 consisting of inorganic material is provided on the thin film 110a mounted on the organic element substrate 100a. The sealing material is not limited to the material or structure depicted in the figure, and can be manufactured in many ways. The thin film 110a, 110b may include heat or light-curing material.

The sealing method of the OLED using the printing method will be explained below in reference to the embodiment depicted in FIG. 7. First, the first substrate 100a provided with the organic element 120 is stably mounted on the table 10, and the thin film 110a consisting of organic material is formed by scan-operating the squeegee on the mask 20 to cover the organic element 120. Here, it is preferable to use the screen printing apparatus described above for the thin film 110a, 110b to form thin films of uniform and even surface. As described above, the stop time of the squeegee 40 may be between about 1 second to about 5 minutes, during which time the mesh part 21 is separated from the thin film that is adjacent to the supporter 23b.

The thin film 110a may be cured partly or completely by applying heat and/or light to the thin film 110a. The reason for curing or partial-curing the thin film 110a in advance is to prevent gas or harmful object generated in curing the thin film 110a from passing to the organic element 120, thereby decreasing or preventing the deterioration of the OLED. If any gas enters the organic element 120, the generated gas can emerge from the screen as air bubbles during the operation of the OLED 5, thereby degrading the quality of pictures. In the embodiment described, gases generated during the curing process are discharged outside of the substrate 100a, 100b since both the films are cured before the substrates are assembled. By performing the curing process before combining the substrates 100a, 100b, deterioration of the organic element 120 from the gas generated during curing can be minimized. As far as curing is concerned, partial curing is preferable because the assembling efficiency of both substrates is good in the partially-cured state and the gases generated during curing can be sufficiently discharged outside of the substrates 100a, 100b by partial curing.

The protective layer 130 consisting of inorganic material is formed on the thin film 110a of the first substrate 100a. Alternatively, the protective layer may include a material that chemically reacts with water and/or oxygen, such as calcium, calcium oxide, barium, and barium oxide, etc. In some embodiments, the thin film 110a may further comprise hygroscopic material.

The thin film 110b is formed on the second substrate 100b using the screen printing apparatus 1 either at the same time as or separately from the thin film 110a. Here, the thin film 110b may be organic film in the pre-cured state.

Once both substrates 100a, 100b are prepared and coupled to each other, the thin films 110a, 110b are cured by applying heat and/or light while pressurizing the substrates. The substrates are coupled in a vacuum chamber, which preferably has a pressure of approximately 760 torr. By performing the coupling in a vacuum chamber, the organic element 120 can be effectively protected from water and oxygen. This sealing process is simple enough to be applicable to mass production without difficulty.

In another embodiment, after forming thin films 110a, 110b consisting of organic material on both substrates 100a, 100b respectively, the stage of curing can be executed in the state of mutually assembling both substrates. Meanwhile, after curing the thin film 110a on the first substrate 100a partially or fully, further curing can be executed while coupling the two substrates.

In yet another embodiment, after forming the thin films 110a, 110b consisting of organic material on both substrates 100a, 100b, and after forming an inorganic film on the thin film 110a of the organic element substrate 100a, the curing can be executed while assembling the two substrates 100a, 100b. The partial-curing or full-curing of the thin film 110a of the first substrate 100a mentioned in FIG. 7 is omitted in this embodiment.

In yet another embodiment, after depositing an organic film, an inorganic film, and an organic film on the first substrate 100a, curing can be executed after assembling the organic element substrate 100a with the sealing substrate 100b. After curing the organic film on the first substrate 100a fully or partially, further curing is executed after assembling the first substrate 100a with the second substrate 100b to thereby form the OLED 5.

As described above, the present invention provides a printing apparatus that can form a uniform thin film on the substrate, a control method thereof, and a manufacturing method of flat panel display employing that the control method.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A printing apparatus comprising:
a table on which a substrate is mounted;
a mask located on the table and comprising a mesh part that is framed by a supporter;
a squeegee positioned to move across the mask to form a thin film on the substrate;
a squeegee driver that drives the squeegee; and
a controller that controls the squeegee driver, wherein the controller stops the squeegee at a boundary area between the mesh part and the supporter for a predetermined time.

2. The printing apparatus according to claim 1, wherein the controller controls the squeegee driver to stop the squeegee until the mesh part is separated from the thin film.

3. The printing apparatus according to claim 1, wherein the controller controls the squeegee driver to stop the squeegee for a time period between about 1 second and about 5 minutes.

4. The printing apparatus according to claim 1, wherein the controller controls the squeegee driver to stop the squeegee on the supporter adjacent to the mesh part.

5. The printing apparatus according to claim 1, wherein the controller determines whether the squeegee is located at a boundary area between the mesh part and the supporter.

6. The printing apparatus according to claim 1, wherein the controller monitors a stop duration of the squeegee.

7. The printing apparatus according to claim 1, wherein a size of the mesh part is the same as or smaller than that of the substrate.

8. The printing apparatus according to claim 7, wherein the mesh part is a rectangular shape.

9. The printing apparatus according to claim 1, wherein a mask frame for sustaining the mask is further provided on an edge of at least one side of the supporter.

10. The printing apparatus according to claim 1, wherein the squeegee executes rectilinear movement as it moves across the supporter.

11. The printing apparatus according to claim 1, wherein the squeegee moves on the mask such that a first direction extending along a side of the squeegee and a second direction in which the squeegee moves maintains a predetermined angle.

12. The printing apparatus according to claim 1, wherein the mask is separated from the table by a predetermined gap, and the squeegee presses the mesh part toward the substrate while holding the film material contained on a side of the supporter in the mesh part during the scan operation.

13. The printing apparatus according to claim 12, wherein the pressurized mesh part changes its shape to contact the thin film, and the mesh part is separated from the thin film after the squeegee passes over the pressured mesh part.

14. The printing apparatus according to claim 12, wherein the supporter moves up and down with the mesh part when the squeegee presses the mesh part.

15. A method of controlling a printing apparatus, comprising:
arranging a mask on a substrate, wherein the mask has a mesh part framed by a supporter;
placing a film material on one side of the supporter;
placing a squeegee on the supporter squeegee;
moving the squeegee across the mask while being pressed against the mesh part toward the substrate;
stopping the squeegee in a boundary area between the supporter and the mesh part for a predetermined time period; and
moving the squeegee toward the supporter after the predetermined time period.

16. The method according to claim 15, wherein the squeegee is controlled to form a thin film on the substrate on the substrate while moving across the mask with the mesh part filled with the film material.

17. The method according to claim 15, wherein stopping the squeegee comprises:
determining whether the squeegee is in the boundary area after moving across the mask; and
stopping the squeegee until the mesh part is separated from the thin film if the squeegee is in the boundary area.

18. The method according to claim 15, wherein stopping the squeegee comprises controlling the squeegee to stop at the supporter and the mesh part for about 1 second to about minutes.

19. A method of manufacturing a flat panel display, comprising:
providing a substrate;
arranging a mask on a substrate, the mask comprising a mesh part framed by a supporter;
forming a thin film on the substrate by moving a squeegee across the mask;
stopping the squeegee for a predetermined time in a boundary area between the mesh part and the supporter;
moving the squeegee after the predetermined time and stopping the squeegee at the supporter.

20. The method according to claim 19, wherein the squeegee is stopped until the mesh part is separated from the thin film.

21. The method according to claim 19, wherein the squeegee stops for a period between about 1 second to about 5 minutes.

22. The method according to claim 19, wherein the squeegee stops on the supporter adjacent to the mesh part.

23. The method according to claim 19, wherein the substrate is one of a first substrate comprising an organic light-emitting layer and a second substrate assembled with the first substrate.

24. The method according to claim 23, further comprising:
assembling the first substrate and the second substrate by placing the substrates in parallel planes after evenly coating at least one of the first substrate and the second substrate, and curing the thin film before the assembling.

25. The method according to claim 24, wherein the first substrate and the second substrate are assembled after partial-curing or curing the thin film formed on the first substrate.

26. The method according to claim 19, wherein the thin film is cured by at least one of heat and light.

27. The method according to claim 19, wherein the thin film is an organic film.
